(19) United States
(12) Patent Application Publication
(10) Pub. No.: US 2023/0210261 A1
(43) Pub. Date: Jul. 6, 2023

(54) Furniture Bumper Protection Device

(71) Applicant: Anneka Turner, Yuba City, CA (US)

(72) Inventor: Anneka Turner, Yuba City, CA (US)

(21) Appl. No.: 17/734,141

(22) Filed: May 2, 2022

Related U.S. Application Data
(60) Provisional application No. 63/294,943, filed on Dec. 30, 2021.

(51) Int. Cl. A47B 91/00

(52) U.S. Cl. CPC A47B 91/00

(57) ABSTRACT

The present invention relates to a furniture bumper protection device which is comprised of an outer surface, an inner surface, a slit, a top surface with a continuous opening and at least one fastener. The device is designed primarily to provide a person protection from accidentally kicking the foot of a piece of furniture and injuring themselves. The device can be placed around a foot of a piece of furniture and has a soft outer surface that may feature differing decorative indicia, designs and fabric to enhance the device's appearance. The slit in the body further has at least one fastener on each side surface of the slit. In this manner, the body may be enclosed and secured around the feet of different pieces of furniture.

### CROSS-REFERENCE TO RELATED APPLICATION

The present application claims priority to, and the benefit of, U.S. provisional application Ser. No. 63/294,943, which was filed on Dec. 30, 2021, and is incorporated herein by reference in its entirety.

### FIELD OF THE INVENTION

The present invention relates generally to the field of furniture protection devices. More specifically, the present invention relates to a furniture bumper protection device which is comprised of an outer surface, an inner surface, a slit, a top surface with a continuous opening and at least one fastener. The device is designed primarily to provide a person protection from accidentally kicking the foot of a piece of furniture and injuring themselves. The device can be placed around a foot of a piece of furniture and has a soft outer surface that may feature differing decorative indicia, designs and fabric to enhance the device's appearance. The slit in the body further has at least one fastener on each side surface of the slit. In this manner, the body may be enclosed and secured around the feet of different pieces of furniture. Accordingly, the present disclosure makes specific reference thereto. Nonetheless, it is to be appreciated that aspects of the present invention are also equally applicable to other like applications, devices and methods of manufacture.

### BACKGROUND

Individuals may walk around their home and accidentally stub their toe on the feet or ends of their furniture. This is a very uncomfortable and painful experience that can lead to serious injury if done with considerable force. Beyond potential injuries, furniture may scratch and damage the floor that it rests upon. This is due to the hard and generally angular design of most furniture feet and edges. To mitigate this effect, some individuals may place soft objects around the legs of their furniture. Others may maneuver their furniture in an unwanted direction and pattern to hide more obtrusive furniture feet. This invariably results in aesthetically unpleasing solutions that fail to provide adequate protection.

Therefore, there exists a long-felt need in the art for a furniture bumper protection device. There also exists a long-felt need in the art to for a furniture bumper protection device that shields the hard and sometimes angular feet of a piece of furniture from the foot of an individual who may be walking by. Moreover, there exists a long-felt need in the art for a furniture bumper protection device that not only protects a passerby, but also protects the floor upon which the furniture is placed from damage. Lastly, there exists a long-felt need in the art for a furniture bumper protection device that is stylish and customizable.

The subject matter disclosed and claimed herein, in one embodiment thereof, comprises a furniture bumper protection device. The device is primarily comprised of a body further comprised of an outer surface, an inner surface, a slit, and a top surface with a continuous opening and at least one fastener. The device can be placed around a foot of a piece of furniture and has a soft outer surface that may feature differing decorative indicia, designs and fabric to enhance the device's appearance. The slit in the body further has at least one fastener on each side surface of the slit. In this manner, the body may be enclosed and secured around the feet of different pieces of furniture.

In this manner, the furniture bumper protection device of the present invention accomplishes all of the foregoing objectives and provides a device that protects both the user's feet and the user's floor from unwanted contact with the feet of the furniture. Further, because of the customizability of the slits and fasteners, the furniture bumper protection device can almost universally be attached on all sizes of furniture feet. Lastly, the device is aesthetically pleasing due to the optional addition of indicia.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a furniture bumper protection device. The device is primarily comprised of a body further comprised of an outer surface, an inner surface, a slit, a top surface with a continuous opening and at least one fastener. The body is primarily made up of two different materials, whereby the outer surface is preferably a soft fabric, and the inner surface is preferably a flexible durable plastic or rubber. The dual materials ensure that both the furniture and the floor are protected while giving the device the ability to withstand heavy weight. The outer surface of the device may also be comprised of decorative indicia to enhance its appearance. Other embodiments of the device may be packaged as a kit, whereby each device follows a general theme of appearance. By means of an example, each device may represent a different sports ball, such as a tennis ball, basketball, baseball, soccer ball, etc.

The device is manufactured with at least one slit to wrap around the foot of a piece of furniture. A continuous opening located at the top of the body allows the furniture foot to fall into the device. Once enclosed, the device may be secured by using fasteners fixed on each side surface of the slit. In this manner, the device shields a furniture foot's hard and sometimes angular surface from coming into contact with a person's foot.

Accordingly, the furniture bumper protection device of the present invention is particularly advantageous as it allows the user to protect his or her feet and toes from hitting the hard surface of a furniture foot and protects the floor from scrapes. Moreover, the device may be customized to aid users in moving their furniture or, on the other hand, keep the furniture steady and in place. Lastly, because the furniture bumper protection device features indicia and can be comprised in any fabric, the device is very stylish and aesthetically pleasing. In this manner, the furniture bumper protection device provides a novel solution for an existing problem.

To the accomplishment of the foregoing and related ends, certain illustrative aspects of the disclosed innovation are described herein in connection with the following description and the annexed drawings. These aspects are indicative, however of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a furniture bumper protection device of the present invention in accordance with the disclosed architecture;

FIG. 2 illustrates a perspective view of one potential embodiment of a kit of a plurality of furniture bumper protection device of the present invention in accordance with the disclosed architecture; and

FIG. 3 illustrates a perspective view of one potential embodiment of a furniture bumper protection device of the present invention while attached around the foot of a piece of furniture in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a furniture bumper protection device. There also exists a long-felt need in the art to for a furniture bumper protection device that shields the hard and sometimes angular feet of a piece of furniture from the foot of an individual who may be walking by. Moreover, there exists a long-felt need in the art for a furniture bumper protection device that not only protects a passerby, but also protects the floor upon which the furniture is placed on from damage. Lastly, there exists a long-felt need in the art for a furniture bumper protection device that is stylish and customizable.

The present invention, in one exemplary embodiment, is comprised of a furniture bumper protection device. The device's body features an outer surface, an inner surface, a slit, a top surface with a continuous opening, and at least one fastener. The inner surface is preferably manufactured with durable plastic or rubber, while the outer surface is preferably manufactured with a soft fabric. This protects both the furniture and the floor and assures that the device can withstand the weight that may be placed upon it. The outer surface of the device may also be comprised of decorative indicia to enhance its appearance. Some embodiments of the device may be packaged as a kit whereby each device follows a general theme. For example, each device may represent a different sports ball.

The device's body is comprised of at least one slit so that the device may wrap around the foot of a piece of furniture. The device receives the furniture foot through a continuous opening located at the top of the body. Once the device is deployed, it may be secured via fasteners fixed on each side surface of the slit. In this manner, the device covers the hard and sometimes angular surface of a furniture foot from a passerby's foot. Thus, if someone were to accidentally kick, hit or stub their toe on the furniture foot, they would not experience immense pain as they otherwise would have without the device. The device also allows a user to easily move their furniture across different surfaces depending on other additions such as, but not limited to, wheels or sliders.

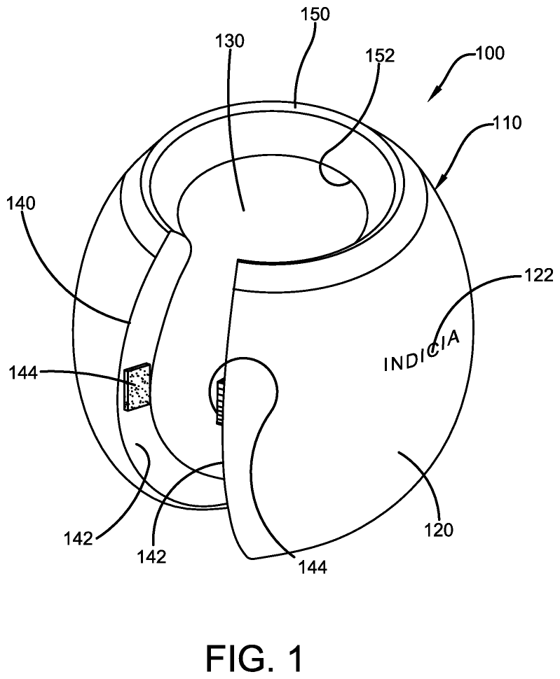

FIG. 1 illustrates a perspective view of one potential embodiment of a furniture bumper protection device 100 of the present invention in accordance with the disclosed architecture. The device 100 is primarily comprised of a body 110 further comprised of an outer surface 120, an inner surface 130, a slit 140, a top surface 150 with a continuous opening 152 and at least one fastener 144. The body 110 of the device 100 is preferably round in shape with a hollow core, but may be any shape known in the art. Different embodiments may be shaped like other objects such as, but not limited to, logos, animals, characters, tools, objects, items, etc. The top surface 150 of the body 110 features an opening 152, whereby a furniture foot 10 can be placed within the device 10 while simultaneously being bound by the device 100. At least one slit 140 runs from the top of the body 110 to the bottom of the body 110. At least one fastener 144 is fixedly attached to each side surface 142 of the slit 140. Preferably, the fastener 144 is a hook and loop fastener, but may be any fastener 144 known in the art such as, but not limited to, snap-button, adhesive, string, magnetic, tongue and groove, etc. Other embodiments may be manufactured with multiple slits 140, allowing the device 100 to be broken down into smaller pieces or more pieces, making the device 100 adaptable to large-diameter furniture feet 10. By means of example, in a circumstance wherein wrapping a furniture foot 10 is infeasible due to the size of the foot 10, a user may enclose the furniture foot 10 by pressing together the multiple portions of multiple devices 100 to create a furniture bumper protection device 100 that more universally fits larger sizes of furniture feet 10.

The inner surface 130 of the device 100 (or the device 100 as a whole) is ideally manufactured from a flexible and durable plastic or rubber. In differing embodiments, the inner surface 130 may be any plastic known in the art such as, but not limited to, acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, etc. The outer surface 120 is ideally manufactured from a soft fabric so that the device 100 does not scratch the user's floor. Said fabric may include a multitude of different fabrics known in the art such as, but not limited to, silk, satin, vinyl, canvas, cashmere, chenille, chiffon, cotton, damask, jersey, lace, linen, wool, modal, polyester, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc. Different embodiments may be manufactured in the same material for both the inner surface 130 and outer surface 120. Other embodiments may feature additions to the fabric, such as an adhesive coating to prevent the furniture from sliding. A non-adhesive coating (i.e., that reduces friction) may be added to aid a user in moving the furniture across a hard-surface floor.

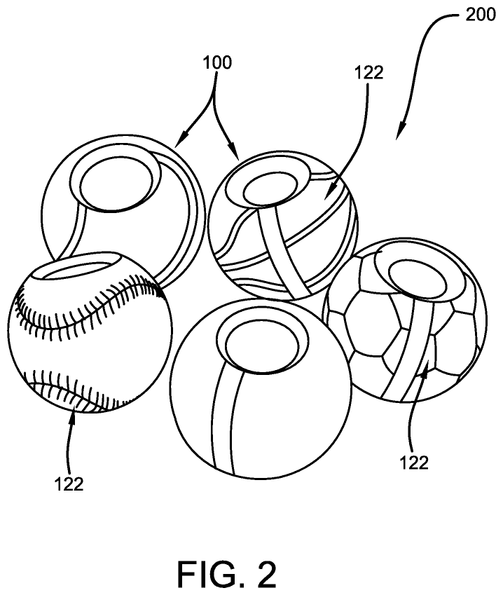

FIG. 2 illustrates a perspective view of one potential embodiment of a kit 200 of a plurality of furniture bumper protection devices 100 of the present invention in accordance with the disclosed architecture. The device 100 may further be any color known in the art. To enhance the appearance of the device 100, the outer surface 120 may be comprised of a plurality of decorative indicia 122 such as, but not limited to, patterns, logos, emblems, images, symbols, designs, letters, words, characters, animals, advertisements, brands, etc. Each device 100 may be customizable to fit users' preferences or be manufactured as a kit 200. By means of an example, each device 100 in a kit 200 may feature a multitude of furniture bumper protection devices 100 which feature indicia 122 depicting them as different sports balls such as, but not limited to, baseballs, tennis balls, basketballs, soccer balls, etc. Other embodiments may be customized to blend into their environment. For example, one device 100 may match the fabric of the user's furniture, while another device 100 may match the color of the user's floor. Other embodiments may feature dual designs (i.e., multiple indicia 122 on the same device 100) so that the device 100 blends into both the user's furniture towards the top of the body 110 and the user's floor towards the bottom of the body 110. Further, the kit 200 may include devices 100 of different sizes and shapes.

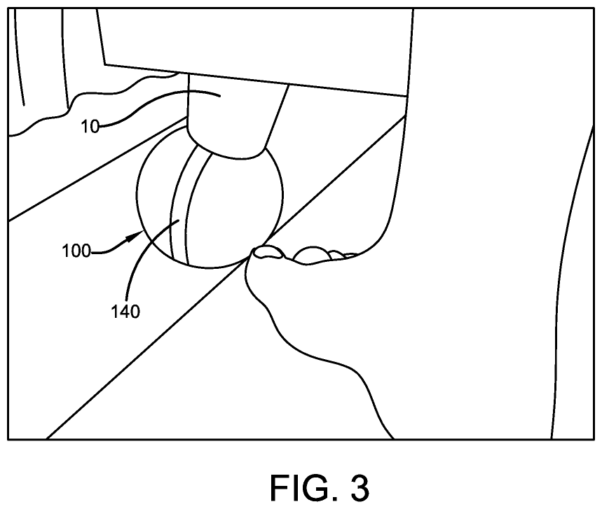

FIG. 3 illustrates a perspective view of one potential embodiment of a furniture bumper protection device 100 of the present invention while attached around the foot 10 of a piece of furniture in accordance with the disclosed architecture. The device 100 preferably accepts the foot of a piece of furniture 10 through the opening 152 located on the top surface 150 of the device 100. The device 100 may be wrapped around and confine the furniture foot 10 by attaching the fasteners 144 on the side surfaces 142 to one another after the device 100 has been placed around the foot 10. Other embodiments that feature multiple slits 140 (and/or multiple devices 100 that attach to one another) may be attached together and secured by multiple fasteners 144 on multiple side surfaces 142 of each device 100. Once fastened, the device 100 will appear as a continuous round shape (or other shaped as mentioned above). After the furniture bumper protection device 100 is deployed, the risk that a user's foot is injured by the furniture foot 10 is significantly reduced. The soft fabric of the outer surface 120 allows the user to kick, hit or stub their toe onto the furniture foot 10 with minimal pain or discomfort. Because of the rounded shape of the device 100, it also protects from scrapes and scratches caused by a more angular furniture foot 10. Beyond its function of protecting the user, the soft fabric of the outer surface 120 also protects the user's floor and mitigates wear and tear on the user's furniture.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “furniture bumper protection device” and “device” are interchangeable and refer to the furniture bumper protection device 100 of the present invention.

Notwithstanding the forgoing, the furniture bumper protection device 100 of the present invention and its various components can be of any suitable size and configuration as is known in the art without affecting the overall concept of the invention, provided that they accomplish the above-stated objectives. One of ordinary skill in the art will appreciate that the size, configuration and material of the furniture bumper protection device 100 as shown in the FIGS. are for illustrative purposes only, and that many other sizes and shapes of the furniture bumper protection device 100 are well within the scope of the present disclosure. Although the dimensions of the furniture bumper protection device 100 are important design parameters for user convenience, the furniture bumper protection device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A furniture bumper protection device comprising:
an outer surface having an indicia;
an inner surface;
a top surface having an opening therein;
a bottom surface;
a slit extending between the outer surface and the inner surface and between the top surface and the bottom surface; and
a pair of side surfaces, wherein each of the pair of side surfaces is further comprised of a fastener.

2. The furniture bumper protection device of claim 1, wherein the fastener of each of the pair of side surfaces is a select one of a hook and loop fastener, a snap-button fastener, an adhesive fastener, a string fastener, a magnetic fastener or a tongue and groove fastener.

3. The furniture bumper protection device of claim 1, wherein the inner surface is manufactured from a rubber material.

4. The furniture bumper protection device of claim 1, wherein the outer surface is manufactured from a fabric material.

5. The furniture bumper protection device of claim 1, wherein the indicia is at least one of a pattern, a logo, an emblem, an image, a symbol, a design, a letter, a word, a character, an animal, an advertisement or a brand.

6. The furniture bumper protection device of claim 1, wherein the opening is sized and configured to receive a furniture leg.

7. The furniture bumper protection device of claim 1, wherein the furniture bumper protection device is shaped like a logo, an animal, a character, a tool, an object or an item.

8. A furniture bumper protection device comprising:
an outer surface;
an inner surface;
a top surface having an opening therein;
a bottom surface;
a slit extending between the outer and the inner surfaces; and
a pair of side surfaces, wherein each of the pair of side surfaces further comprised of a fastener.

9. The furniture bumper protection device of claim 8, wherein the fastener of each of the pair of side surfaces is a select one of a hook and loop fastener, a snap-button fastener, an adhesive fastener, a string fastener, a magnetic fastener or a tongue and groove fastener.

10. The furniture bumper protection device of claim 8, wherein the inner surface is manufactured from a rubber material.

11. The furniture bumper protection device of claim 8, wherein the outer surface is manufactured from a fabric material.

12. The furniture bumper protection device of claim 8 further comprising an indicia.

13. The furniture bumper protection device of claim 12, wherein the indicia is at least one of a pattern, a logo, an emblem, an image, a symbol, a design, a letter, a word, a character, an animal, an advertisement or a brand.

14. A furniture bumper protection device comprising:
an outer surface comprised of a fabric;
an inner surface;
a top surface having an opening therein;
a bottom surface;
a slit extending between the top and bottom surfaces; and
a pair of side surfaces.

15. The furniture bumper protection device of claim 14 further comprising a fastener positioned on each of the pair of side surfaces and configured to engage one another.

16. The furniture bumper protection device of claim 15, wherein the fastener is a select one of a hook and loop fastener, a snap-button fastener, an adhesive fastener, a string fastener, a magnetic fastener or a tongue and groove fastener.

17. The furniture bumper protection device of claim 16, wherein the inner surface is manufactured from a rubber material.

18. The furniture bumper protection device of claim 17 further comprising an indicia positioned on the outer surface.

19. The furniture bumper protection device of claim 18, wherein the indicia is at least one of a pattern, a logo, an emblem, an image, a symbol, a design, a letter, a word, a character, an animal, an advertisement or a brand.

20. The furniture bumper protection device of claim 19, wherein the furniture bumper protection device is in the shape of an animal, a character, a tool or a sporting good.
